(19) United States
(12) Patent Application Publication
(10) Pub. No.: US 2009/0063262 A1
(43) Pub. Date: Mar. 5, 2009

(54) BATCHING AD-SELECTION REQUESTS FOR CONCURRENT COMMUNICATION

(75) Inventor: R. BRYANT MASON, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/848,457

(22) Filed: Aug. 31, 2007

(51) Int. Cl. G06Q 30/00; G06F 17/30

(52) U.S. Cl. 705/14

(57) ABSTRACT

Methods, systems, and computer-storage media having computer-executable instructions embodied thereon that, when executed, perform methods in accordance with embodiments hereof, for batching requests into calls. Initially, an indication to present a web page is sent from an input device that triggers a web browser to download and execute source code underlying the requested web page. The executed source code instructs the web browser to send one or more ad-selection requests to an ad-delivering engine. The web browser batches the ad-selection selection requests into a retrieval call such that the ad-selection requests are communicated concurrently. The ad-delivering engine parses the retrieval request, extracts parameters from the parsed ad-selection requests, distributes the parameters to back-end servers, and batches location indicators of advertisements that correspond to the parameters into a response call. The web browser receives and parses the response call, and renders ad content based on the location indicators of advertisements.

### BACKGROUND

Loading web pages on a computer can be a particularly time consuming, resource-intensive process. Web pages are provided by Internet web sites and usually include at least one reference to an advertisement (“ad”) within the underlying source code, which defines the attributes of the web page. These ads are displayed as part of the web page when loaded by Internet client software, such as a web browser, typically as static images or active content. During the process of loading the page web by the Internet client software, content for each ad is dynamically delivered by an Internet ad provider. Various approaches have been used to trigger an Internet ad provider to deliver content. For example, some Internet ad providers embed a unique call within the underlying code of the web page. This call instructs the Internet client software to make multiple requests to the Internet ad-provider servers via an Internet connection. In response to the multiple requests, communications with ad content are returned to the Internet client software for incorporation into the web page intended for display.

While the multiple requests are useful for seeking out ad content, there are many inefficiencies inherent in conducting ad requests in this manner. For example, each of the multiple requests individually utilizes network capacity, which negatively impacts the web page download performance and the end-user experience. Accordingly, the present ad-selection framework fails to provide an optimal use of Internet bandwidth.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to methods, systems, and computer-storage media having computer-executable instructions embodied thereon that, when executed, perform methods in accordance with embodiments hereof, for batching one or more requests for location indicators into a single call. Initially, an indication to present a web page is sent from an input device (e.g., user-initiated action from an end user at a computing device). The indication triggers a web browser, Internet client software, or any other file-searching mechanism and/or application (hereinafter referred to generally as “web browser”) to download and execute source code underlying the requested web page. The source code may have references therein that, when executed, instruct the web browser to send one or more ad-selection requests to an ad-delivering engine. However, prior to sending these requests, the web browser batches (i.e., automatically aggregates) the ad-selection selection requests into a retrieval call such that the ad-selection requests are concurrently communicated to the ad-delivering engine. In one embodiment, when batching, the retrieval call is formatted based on a shared script library (e.g., JavaScript Library) that has functions understood by both the web browser and the ad-delivering engine.

Incident to receipt of the retrieval call, the ad-delivering engine executes a set of ad-selection procedures. These procedures include the following steps: parsing the retrieval request, extracting parameters from the parsed ad-selection requests, distributing the parameters to back-end servers, and collecting location indicators of advertisements that correspond to the parameters. In one embodiment, these location indicators are packaged by the ad-delivering engine into a response call. Subsequently, the web browser receives and parses the response call, and processes the location indicators. Further, the web browser may render a web page at a user interface with ad content that is based on the location indicators of advertisements.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system suitable for use in implementing embodiments of the present invention;

FIG. 3 is a block diagram of an exemplary computing device having a web-browsing application residing thereon, in accordance with an embodiment of the present invention;

FIG. 4 is a flow diagram showing a method 400 for batching one or more ad-selection requests and location indicators of advertisements, in accordance with an embodiment of the present invention.

FIGS. 5A and 5B is a diagrammatic chart showing a method for batching ad-selection requests and location indicator for concurrent communication, in accordance with an embodiment of the present invention; and

FIG. 6 is an illustrative screen display of an exemplary user interface for presenting a web page the has web content, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods, systems, and computer-storage media having computer-executable instructions embodied thereon that, when executed, perform methods in accordance with embodiments hereof, for batching ad-content information into a call.

Accordingly, in one aspect, embodiments of the present invention relate to one or more computer-storage media having computer-executable instructions embodied thereon that, when executed, perform a method for batching one or more ad-selection requests into a retrieval call. The method includes at least the following steps: receiving an indication to present a web page, where the web page is defined by underlying source code that, when executed, instructs the web browser to send one or more ad-selection requests, generating a retrieval call by batching one or more ad-retrieval requests, communicating the retrieval call to an ad-delivering engine, where the ad-delivering engine provides location indicators of advertisements—based on the ad-selection requests—that are packaged as a response call, and receiving the response call at the web browser. The method may further include the step of rendering the web page at a user interface. In one embodiment, the rendered web page is populated with ad content based on the location indicators of advertisements.

In another aspect, embodiments of the present invention relate to a computer system embodied on one or more computer-storage media having computer-executable instructions embodied thereon for performing a method for batching ad selection requests for concurrent communication to an ad-delivering engine. The system includes a request-receiving component, a code-executing component, a request-batching component, an ad-delivering component, and a rendering component. The request-receiving component is configured for receiving an indication from an input device to present a web page, where the web page has underlying source code. The code-executing component is configured for launching the ad-selection requests by executing the source code. Next, the request-batching component is configured for automatically aggregating the ad-selection requests such that the aggregated ad-selection requests are concurrently communicated to an ad-delivering engine. The ad-delivering engine is configured for executing ad-selection procedures that include providing location indicators to advertisements selected according to each of the ad-selection requests. Further, the rendering component is provided for rendering the web page at a user interface, where the web page may be populated with ad content collected according to the location indicators of advertisements.

In yet another aspect, embodiments of the present invention relate to one or more computer-storage media having computer-executable instructions embodied thereon that, when executed, perform a method for batching, in a response call, one or more location indicators of advertisements according to one or more ad-selection requests, the method includes receiving a retrieval call from a web browser, where the retrieval call comprises one or more ad-selection requests, executing an ad-selection procedure that includes selecting one or more location indicators of advertisements according to the one or more ad-selection requests, and packaging the one or more location indicators into a response call. The method may further comprise communicating the response call to the web browser such that the web browser may render a web page that is populated with ad content. In one embodiment, the ad content is associated with the one or more location indicators of advertisements.

Having briefly described an overview of embodiments of the present invention, an exemplary operating environment suitable for implementing the present invention is described below.

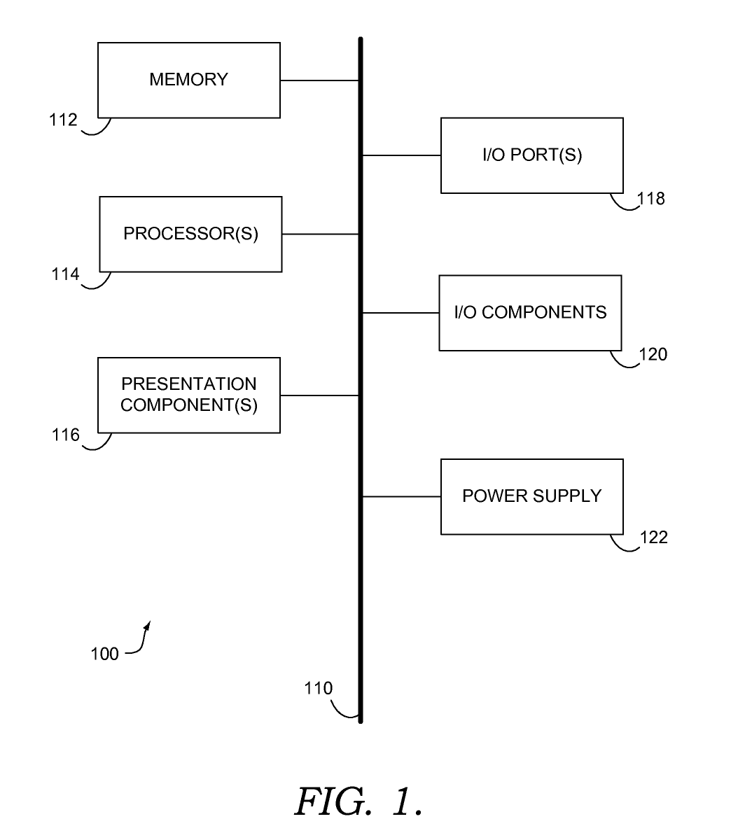

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code (e.g., source code) or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user (e.g., user interface) or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

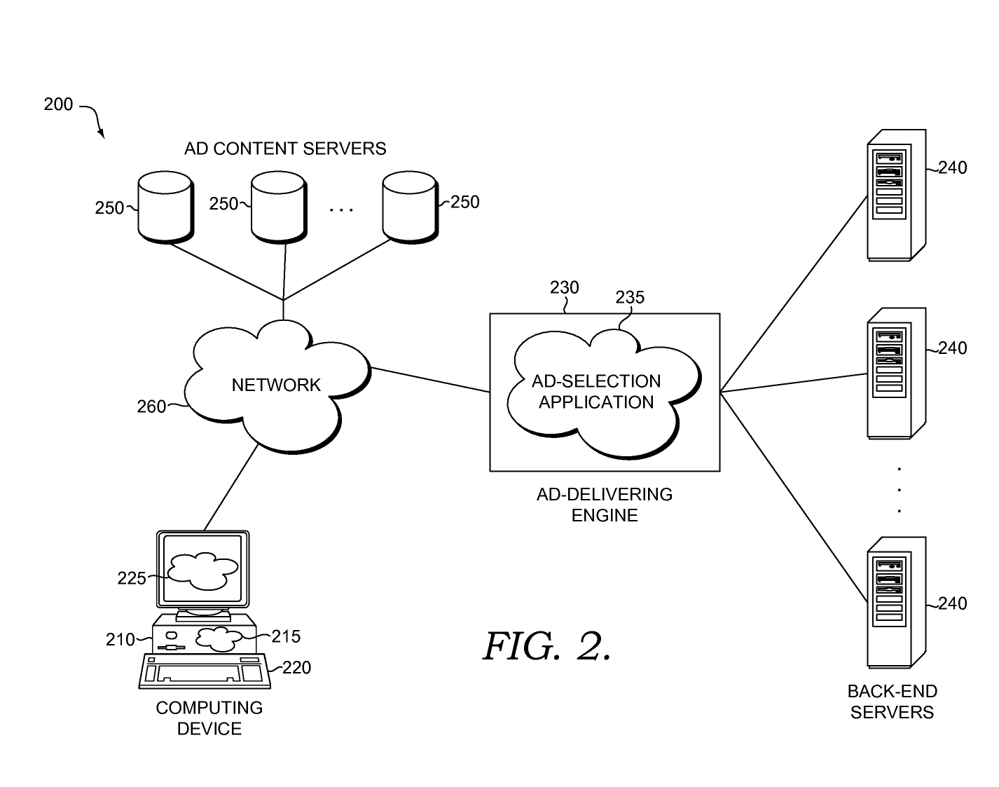

Turning now to FIG. 2, a block diagram is illustrated, in accordance with an embodiment of the present invention, showing an ad-selection system 200 configured to batch ad-selection requests communicated from a web browser and package location indicators to advertisements in response thereto. It will be understood and appreciated by those of ordinary skill in the art that the ad-selection system 200 shown in FIG. 2 is merely an example of one suitable computing system environment and is not intended to suggest any limitation as to the scope of use or functionality of embodiments of the present invention. Neither should the ad-selection system 200 be interpreted as having any dependency or requirement related to any single component or combination of components illustrated therein. Further, the program ad-selection system 200 may be provided as a stand-alone product, as part of a software development environment, or any combination thereof.

The ad-selection system 200 includes a computing device 210 that has an input device 220 and a user interface 225 operably couple thereto, an ad-delivering engine 230, a plurality of back-end servers 240, and a plurality of ad content servers 250, all in communication with one another via a network 260. The network 260 may include, without limitation, one or more local area networks (LANs) and/or wide area networks (WANs). Such networking environments are commonplace in offices, enterprise-wide computer networks, intranets, and the Internet. Accordingly, the network 260 is not further described herein.

The ad content servers 250 are configured to store image data and other information that, when rendered by the web browser, may be presented as ad content within a web page presented on a user interface. In various embodiments, such image data may include, without limitation, information related to media files, static images, active content with animated or interactive attributes, dynamically hypertext markup language (DHTML) code, and the like. In embodiments, the ad content servers 250 are configured to be searchable for one or more of the image data stored in association with a location indicator of an advertisement, typically provided by the web-browsing application 215. It will be understood and appreciated by those of ordinary skill in the art that the image data stored in the ad content servers 250 may be configurable and may include any information relevant to rendering a web page or advertisements. The content and volume of such information is not intended to limit the scope of embodiments of the present invention in any way. Further, though illustrated as a plurality of components, ad content servers 250 may, in fact, be a single or conglomeration (e.g., database cluster) of databases, where portions of which may reside on the computing device 210, the ad-delivering engine 230, the back-end servers 240, another external computing device (not shown), and/or any combination thereof.

Each of the computing device 210, the ad-delivering engine 230, the back-end servers 240, and the ad content servers 250 shown in FIG. 2 may be any type of computing device, such as, for example, computing device 100 described above with reference to FIG. 1. By way of example only and not limitation, each of the computing device 210, the ad-delivering engine 230, the back-end servers 240, and the ad content servers 250 may be a personal computer, desktop computer, laptop computer, handheld device, mobile handset, consumer electronic device, and the like.

Additionally, the computing device 210 may further include an input device 220 that may be one or more of a keyboard, keypad, stylus, joystick, and any other input-initiating component that allows a user or software internal to the computing device 215 or other component within the ad-selection system 200 to provide wired or wireless data to the network 250. It should be noted, however, that the present invention is not limited to implementation on such computing devices, but may be implemented on any of a variety of different types of computing devices within the scope of embodiments hereof.

Further, the computing device may further include a user interface 225. Where a representation of a web page is displayed, end users may utilize devices (e.g., monitor, display screen, presentation component(s) 116 of FIG. 1, and the like) that render, or display, an interface, which may include a graphical user interface (GUI), database or scripting interface, menu driven interface, etc., that is collectively referred to herein as a user interface (UI) 225. In one embodiment, the user interface 225 can send data (e.g., content and/or instructions) that triggers the web page to reload, similar to the input device 220.

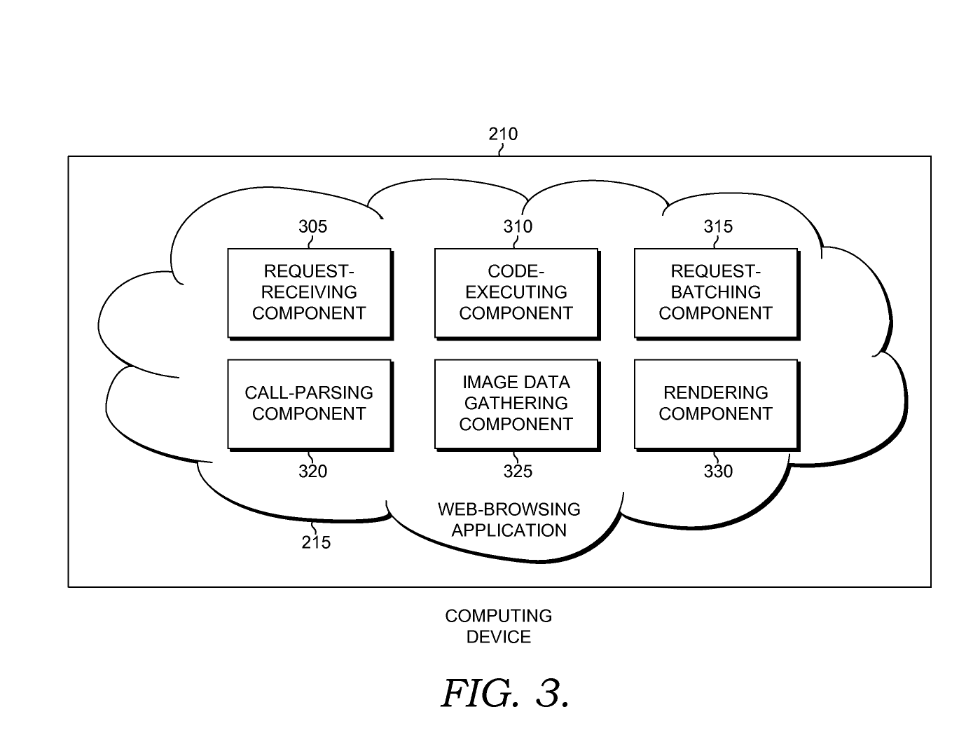

As shown in FIG. 2, the computing device 210 is configured to execute source code underlying a web page, aggregate ad-selection requests, render ad content on a web page, and other functions performed in association with the process of selecting and/or presenting ad content. Execution is performed by a web browser application 215 that, in embodiments, is initiated upon receiving an indication from the input device 220 to present a web page. Turning now to FIG. 3, the web-browsing application 215 includes a request-receiving component 305, a code-executing component 310, a request-batching component 315, a call-parsing component 320, and an image data gathering component 325, and rendering component 330. In some embodiments, one or more of the illustrated components 305, 310, 315, 320, 325, and 330 may be implemented as stand-alone applications. In other embodiments, one or more of the illustrated components 305, 310, 315, 320, 325, and 330 may be integrated directly into the operating system of the computing device 210 and/or the ad-delivering engine 230 (with reference to FIG. 2). By way of illustration only, the request-receiving component 305 may be housed in association with the input device 220, while the image data gathering component 325 may be housed in association with the ad-delivering engine 230 or may be incorporated within one or more of the plurality of ad content servers 250. It will be understood by those of ordinary skill in the art that the components 305, 310, 315, 320, 325, and 330 illustrated in FIG. 3 are exemplary in nature and in number and should not be construed as limiting. Any number of components may be employed to achieve the desired functionality within the scope of embodiments of the present invention.

With continued reference to FIG. 3, the request-receiving component 305 is configured for receiving an indication from an input device (e.g., input device 220) to present a web page. In one embodiment, the indication is a computer-generated command, such as an instruction for the web-browsing application 215 to transition to the next successive web page. In another embodiment the indication is a user-initiated action from an end user at the input device. Examples of such user-initiated actions include, without limitation, requests to view a web page, reloading a web page, selection of a hyperlink, or any other trigger event that prompts the web-browsing application to retrieve source code related to a web page.

Typically, the web page being retrieved has underlying source code (e.g., hypertext markup language (HTML) data, Java script, etc.) that defines the web page. The source code may be retrieved from various sources (not shown) such as the web site that sponsors or hosts the web page. In particular, the underlying source code determines attributes (size, color, location of ads, and the like), main-page content, and ad content of the web page. In one embodiment, the ad content is requested by references embedded in the underlying source code.

A code-executing component 310 is configured for launching the ad-selection requests by executing the source code. With more particularity, the references (discussed above) embedded within source code, when executed, instruct the web-browsing application 215 to send an ad-selection request. By way of example, upon executing each reference, a single ad-selection request is derived therefrom. Typically, launching ad-selection requests is a process that is triggered upon retrieving the source code for the indicated web page.

The request-batching component 315 is configured for packaging the ad-selection requests. In one embodiment, packaging comprises aggregating the ad-selection requests into a retrieval call. Although a single retrieval call is discussed herein, the present invention contemplates aggregating one or more of the ad-selection requests into one or multiple retrieval calls. In an exemplary embodiment, upon receiving instructions to send retrieval calls, the request-batching component 315 automatically aggregates the ad-selection requests by way of a browser-initiated, user-transparent process. As such, incident to aggregation, the aggregated ad-selection requests may be concurrently communicated to an ad-delivering engine 230 (FIG. 2).

In embodiments, batching the ad-selection requests is supported by a shared script library (such as a JavaScript Library) that includes functions, or blocks of code directed at a particular action, which are understood by both the web-browsing application 215 and the ad-delivering engine 230. That is, the retrieval request, generated upon batching, includes at least one function from the shared script library that may be interpreted by numerous remote servers, engines, computing devices, or any combination thereof. Some examples of functions may be commands to render ads, batch code syntax (discussed below), and parse code syntax. Advantageously, by implementing a common format of the script of the retrieval requests, various web-browsing applications 215 can communicate requests with a plurality of ad-delivering engines 230 (FIG. 2). In embodiments, this shared script library may be automatically downloaded to the computing device 210 when running the web-browsing application 215; accordingly, any updated information in the shared script library is downloaded, allowing the components on the network 260 to access a manifest of universal adaptable script.

In addition to concurrently communicating the ad-selection requests to the ad-delivering engine 235 (FIG. 2), the request-batching component 315 may provide supplemental parameters within the retrieval call. In embodiments, the supplemental parameters relate to attributes (e.g., size, shape, location, etc.) of the ad content on the web page being rendered on the user interface 225. Thus, the supplemental parameters and the ad-selection requests may be utilized in tandem to determine the advertisements to be placed on the web page.

This determination is performed at the ad-delivering engine 230. In particular, the ad-delivering engine includes an ad-selection application 235 residing thereon for executing a set of ad-selection procedures. These ad-selection procedures comprise the following steps: parsing the retrieval request, extracting parameters from the parsed ad-selection requests, distributing the parameters to back-end servers, and collecting location indicators of advertisements that correspond to the parameters. Parsing the retrieval request may encompass interpreting the functions of the retrieval call that are formatted according to the shared script library. Parsing may further include separating the retrieval request into manageable portions of information (e.g., individual ad-selection requests) that may be interpreted by the ad-selection application 235. Interpreting may comprise extracting parameters from the parsed ad-selection request for distribution to the back-end servers 240. These extracted parameters (e.g., size of the advertisement, information about the taxonomy of the page, and other data used to select the ad) assist in targeting the appropriate advertisement for each ad-selection request.

As discussed more fully above, the back-end servers 240 are typically computing devices configured to analyze the parameters and supplemental parameters such that at least one or more advertisements that correspond to the parameters can be selected. In one embodiment, the back-end servers 240 utilize an ad-determination algorithm for identifying the advertisements that correspond to the parameters. Typically the algorithm dynamically selects the advertisement each time parameters are received. Dynamic selection may include rotational selection (i.e. identify ads that were different that the previous ads identified), or by some other logic (e.g., identify ads based on content to the web page or other supplemental parameters). In response to receiving these parameters, the back-end servers 240 provides location indicators of the advertisements, such as an indication of which advertisement was selected. In embodiments, the location indicators have embedded therein a request link to a specific image data of an advertisement.

Returning to the ad-delivering engine 230, these location indicators are packaged by the ad-selection application 235 into a response call. Similar to the retrieval call, the packaging or batching of the location indicators is supported by a shared script library framework such that the functions which are incorporated in the response call by the ad-delivering engine 230 are understood by the web-browsing application 215 residing on the computing device 210. In one embodiment, packaging the location indicators of advertisements is a step within the ad-selection procedure. In another embodiment, the packaging the location indicators comprises aggregating the location indicators to advertisements such that the aggregated location indicators are concurrently communicated to a web-browsing application 215 that is executed on the computing device 210. As used herein, “location identifier” is not meant to be construed as limiting and may comprise an address that identifies the location of a file on a server, typically on the Internet or within an intranet (e.g., Universal Resource Locator (URL)). As should be understood and appreciated by persons familiar with the field of the invention, the location identifier may be embodied as a protocol that identifies a server upon which a particular file resides, the location of the file on the server, or a combination thereof.

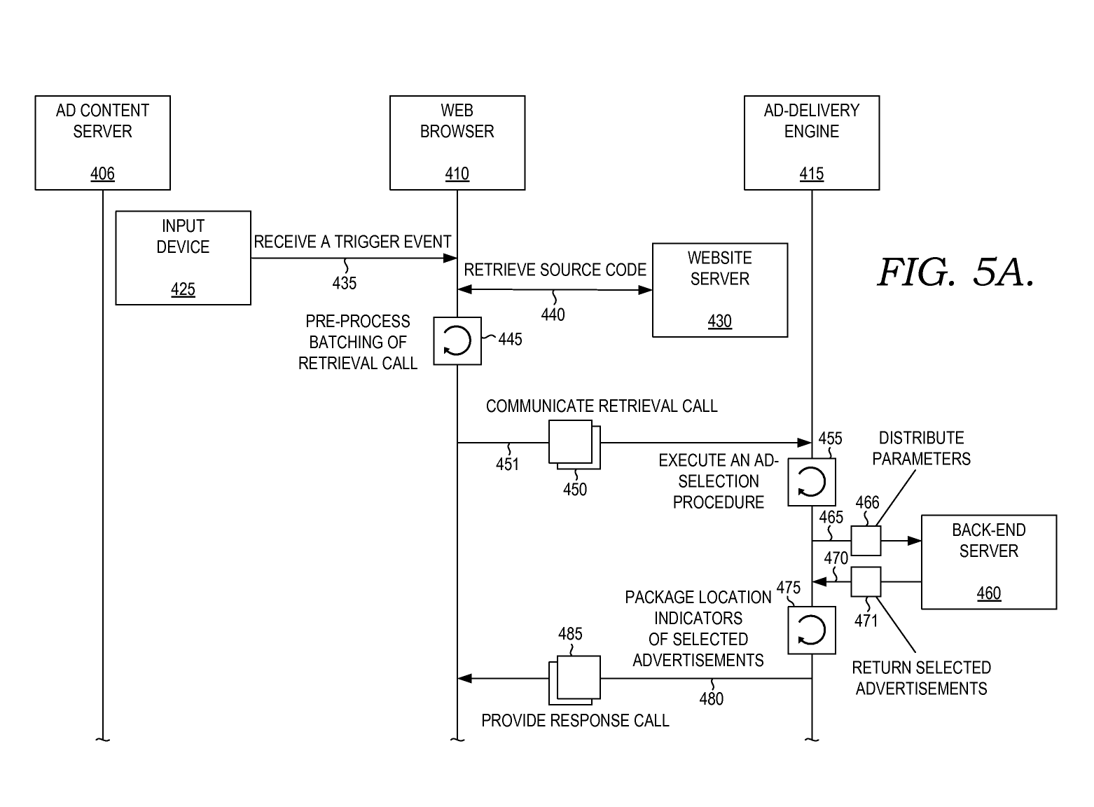

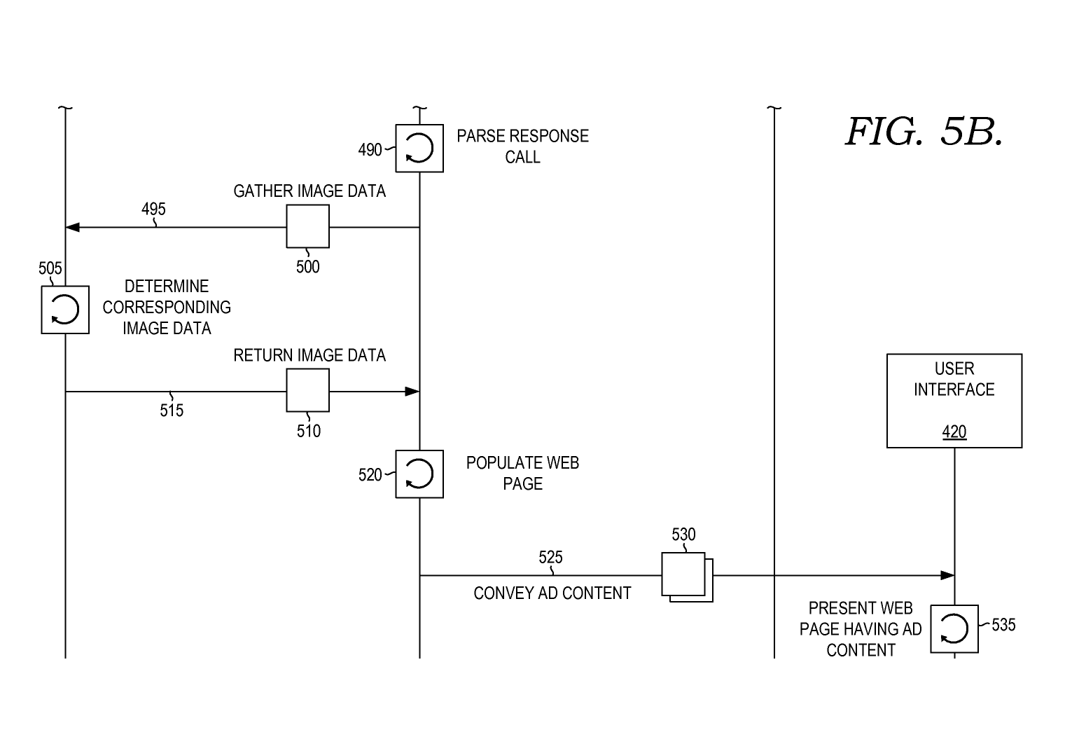

Returning to the operation of the web-browsing application 215, as illustrated at FIG. 3, the call-parsing component 320 is configured for parsing the aggregated location indicators of advertisements such that each location indicator of an advertisement can be processed independently. Accordingly, the request links to a specific image data of an advertisement embedded within the location indicators may be executed to collect the image data. In one embodiment the image data is collected from a plurality of ad content servers 250. This process of retrieving image data is discussed more fully with reference to FIG. 5.

Next, the image data gathering component 325, configured for gathering image data incident to processing the location indicators to advertisements, gather the image data from one or more ad content servers, as directed by the request links of the location indicators of advertisements. This image data, upon collection, as well as the original information received in the response call, may be stored in association with at least one data store (not shown) on the computing device 210 or at any other component within the network 260.

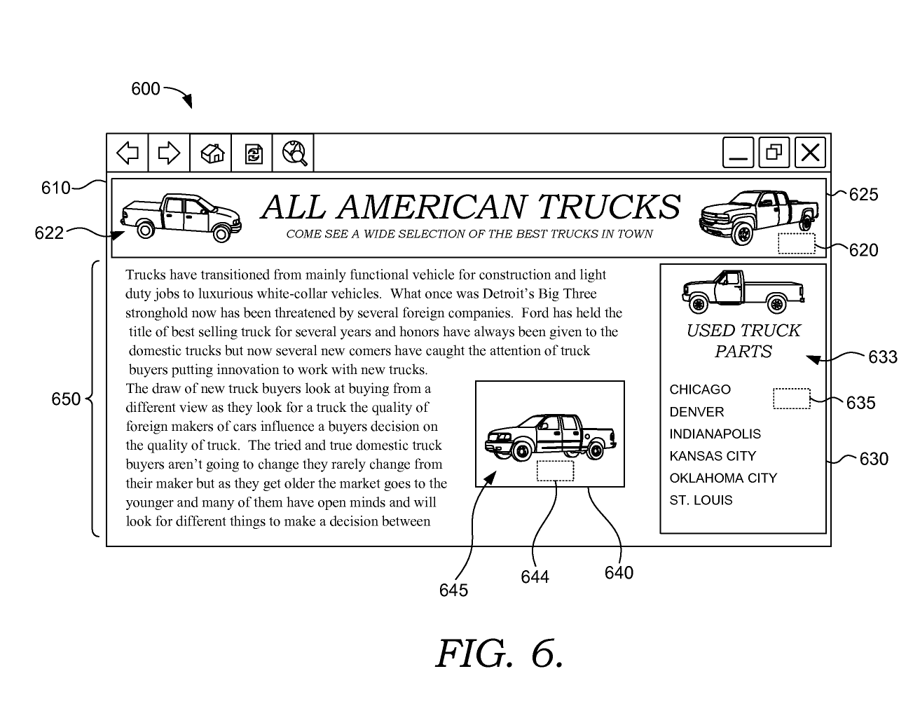

Incident to collecting the image data, a rendering component 330 for rendering the web page at a user interface, renders the ad content of the web page based on the location indicator. In particular, the rendering process comprises converting the collected image data to ad content suitable for presentation on the user interface 225. In another embodiment, the rendering process populates the web page with ad content based on the supplemental parameters initially used to identify the location indicators of advertisements. One result of the rendering component 330 is a presentation of the ad content on a user device as detailed more completely in FIG. 6. As such, ad content is rendered, relying on steps of batching the ad-selection requests and location indicator, in a manner that reduces resource and operational costs by reducing the amount of calls transmitted between components of the network 260. In particular, by consolidating the requests to packaged calls, more free bandwidth is available so that other web page content may be retrieved in parallel giving the end user an improved experience, such as faster overall web page load times.

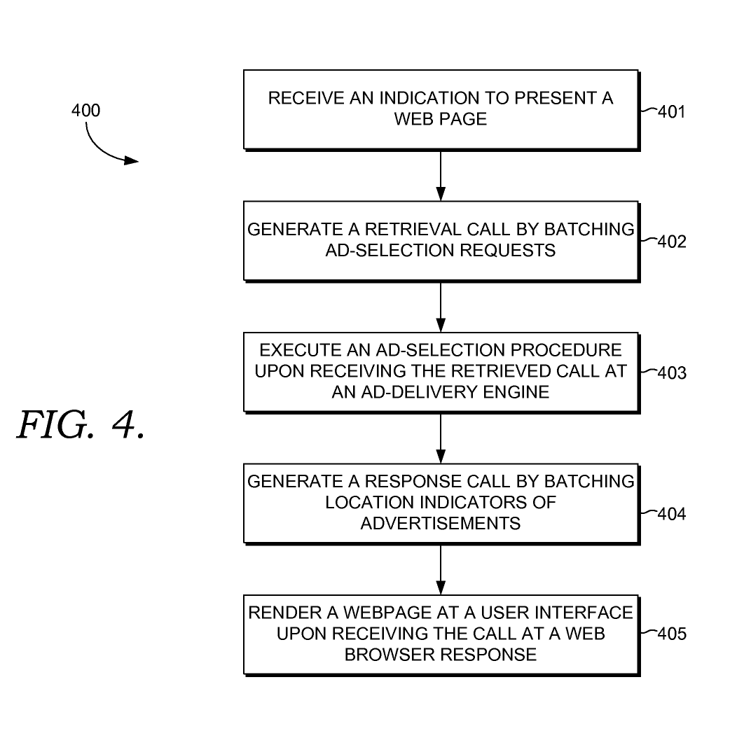

Turning now to FIG. 4, a flow diagram is illustrated that shows a method 400 for batching one or more ad-selection requests and location indicators of advertisements, in accordance with an embodiment of the present invention. Initially, as indicated at block 401, an indication, such as a mouse-click from an end user, to present a web page on a user interface is received at the web-browsing application. A retrieval call is then generated by batching the ad-selection requests, where the ad-selection requests are typically launched from the web-browsing application upon executing source code underlying the web page. This step is indicated at block 402. Next, as indicated at block 403, an ad-selection procedure is executed upon receiving the retrieval call at an ad-delivering engine. The ad-selection procedure includes at least the following steps: parsing the retrieval request, extracting parameters from the parsed ad-selection requests, distributing the parameters to back-end servers, and collecting location indicators of advertisements that correspond to the parameters. A response call is generated upon batching the location indicators of advertisements, as indicated in block 404. The response call is received and rendered at the web-browsing application such that ad content associated with the location indicators may be presented at a user interface, as indicated at block 405.

With reference to FIGS. 5A and 5B, a diagrammatic chart is illustrated that shows a method for batching ad-selection requests and location indicators for concurrent communication, in accordance with an embodiment of the present invention. Initially, a trigger event 435 is received from an input device 425. By way of example only, the trigger even may be generated by a computing device (e.g., computing device 210), or a user-action generated by the end user. Based on the trigger event, a web page is selected for retrieval. The source code 440 for the selected web page is retrieved from a web server 430 so that it may be loaded on the web browser 410.

Once the source code 440 is loaded, the web browser 410 executes the source code 440, where references within the source code 440 instruct the web browser 410 to send one or more ad-selection requests. A pre-process batching of retrieval call that collects and/or packages one or more ad-selection requests 450 is run in order to concurrently communicate the ad-selection requests 450 concurrently in a retrieval call. In one embodiment, when batching, the retrieval call is formatted based on a shared script library (e.g., JavaScript Library) that has functions understood by both the web browser 410 and the ad-delivering engine 415. In another embodiment, the web browser 410 formats the retrieval call as Hyper-Text Transfer Protocol (HTTP) such that both the web browser 410 and the ad-delivery engine 415 can read and interpret the transmission. Other protocols for formatting transmissions between the components of the system discussed herein may be used and are contemplated by the present invention. In embodiments, the client-side components and server-side components utilize a common protocol that is understandable to each. Upon receiving the retrieval call, an ad-selection procedure 455 is performed. The ad-selection procedure 455 includes the following steps: parsing the retrieval call, extracting parameters 466 from the parsed ad-selection requests 450, distributing the parameters 465 to a back-end server 460, and receiving returned selected advertisements 470 from the back-end server 460. Typically, parameters 466 that are distributed 465 include information that the back-end server 460 can enter into an ad-selection algorithm to select corresponding advertisements 471.

Location indicators, or indicia, directed to the selected advertisements 471 are packaged 475 into at one or more response calls. The response call that has one or more location indicators of advertisements 485 incorporated therein, typically conveyed as subsections of a response call. Subsequently, the web browser 410 receives the response call provided 480 by the ad-delivering engine 415 and parses the response call 490. In one embodiment, the location indicators of advertisements 485 have a request link appended thereto that targets image data upon the web-browser 410 sending a query to gather image data 495. In one embodiment, the query is formatted, incident to sending, as Hyper-Text Transfer Protocol (HTTP) such that both the web browser 410 and the ad content server 406 can read and interpret the transmission. The ad content server 406 performs a step that determines the image data that corresponds to the request link 505. The image data 510 is returned to the web browser 410.

The web browser 410 may initiate a rendering process whereby ad content is generated based on the image data. The ad content is populated on the web page 520 that is asynchronously being rendered for presentation to a user. In an exemplary embodiment, the ad content 530 is conveyed 525 to a user interface 430 for presentation to an end user (e.g., display on the user interface 225 of FIG. 2). The user interface 420 will then present the ad content on the web page 435.

Turning now to FIG. 6, illustrative screen display 600 of exemplary user interface for presenting a web page 610 is shown in accordance with embodiments of the present invention. The web page includes main-page content 650 and ad content 622, 633, and 645. The ad content 622, 633, and 645 is based on parameters that are sent in the ad-selection requests that are sent to the ad-delivering engine. Information in the parameters may include data related to the main-page content 650 and the insertion data (size, shape, and location) of the ad content 622, 633, and 645. For instance, insertion data 625 of the ad content 622 may include an indication that the ad content 622 is in the form of a banner ad located at an upper portion of the web page 610. The insertion data 630 for ad content 633 may include an indication that the ad content 633 is in the form of a skyscraper-style ad located on a right portion of the web page 610 having content related to the main-page content 650. Further, the insertion data 640 for ad content 645 may include an indication that the ad content 645 is in the form of a small box ad located on a lower portion of the web page 610 that may be a dynamic ad expressing movement.

Incident to the ad-delivering engine receiving the ad-selection request that are batched to create a retrieval call (discussed above), the ad-delivering engine parses the retrieval call to determine the parameters therein. Based on the insertion data 625, 630, and 640, the ad-delivering engine returns location indicators 620, 635, and 644 that correspond to the insertion data 625, 630, and 640. In one embodiment, the location indicators 620, 635, and 644 are populated into the web page such that, when rendered, the location indicators 620, 635, and 644 direct the web browser to present associated ad content 622, 633, and 645. As such, the ad content 622, 633, and 645 is rendered with minimal calls between the ad-delivering engine and the web browser, yet are rendered according a variety of data providing a robust ad-selection procedure.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-storage media having computer-executable instructions embodied thereon that, when executed, perform a method for batching one or more ad-selection requests into a retrieval call, the method comprising:
receiving an indication from an input device to present a web page, the web page having source code that, when executed, instructs a web browser to send the one or more ad-selection requests;
generating the retrieval call by batching the one or more ad-selection requests;
communicating the retrieval call to an ad-delivering engine, wherein the ad-delivering engine is configured to provide one or more location indicators of advertisements according to each of the one or more ad-selection requests, the one or more location indicators are conveyed as subsections of a response call;
receiving the response call at the web browser; and
rendering the web page at a user interface based, in part, on the one or more location indicators of the response call.

2. The one or more computer-storage media of claim 1, wherein rendering the web page at a user interface comprises populating the web page with ad content, the ad content collected according to the one or more location indicators.

3. The one or more computer-storage media of claim 1, wherein receiving an indication comprises receiving a user-initiated action to present a web page by an end user operating the input device.

4. The one or more computer-storage media of claim 1, wherein the method further comprises:
retrieving the source code for the web page, indicated by the input device, from a website server, the source code having references embedded therein; and
executing the source code, the references instructing the web browser to send the one or more ad-selection requests.

5. The one or more computer-storage media of claim 4, wherein generating the retrieval call comprises:
identifying the one or more ad-selection requests upon executing the source code; and
automatically aggregating the one or more ad-selection requests in a user-transparent manner such that the one or more ad-selection requests are communicated to the ad-delivering engine concurrently.

6. The one or more computer-storage media of claim 1, wherein the method further comprises reading the one or more location indicators by parsing the subsections of the response call.

7. The one or more computer-storage media of claim 1, wherein the source code comprises HTML data that defines attributes of the page.

8. The one or more computer-storage media of claim 1, further comprising:
automatically downloading a shared script library, wherein the shared script library comprises at least one function that is understood by the ad-delivering engine and the web browser; and
formatting underlying code of the retrieval call by incorporating the at least one function of the shared script library.

9. The one or more computer-storage media of claim 1, wherein generating the retrieval call is performed by the web browser asynchronously with other functions related to rendering the web page.

10. A computer system embodied on one or more computer-storage media having computer-executable instructions embodied thereon for performing a method for batching ad-selection requests for concurrent communication to an ad-delivering engine, the system comprising:
a request-receiving component for receiving an indication from an input device to present a web page, the web page having underlying source code;
a code-executing component for launching the ad-selection requests by executing the source code;
a request-batching component for automatically aggregating the ad-selection requests, the aggregated ad-selection requests being concurrently communicated to an ad-delivering engine;
the ad-delivering engine for executing ad-selection procedures, the ad-selection procedures comprising providing location indicators of advertisements, each of the location indicators of advertisements selected according to each of the ad-selection requests; and
a rendering component for rendering the web page at a user interface, the web page being populated with ad content collected according to the location indicators to advertisements.

11. The one or more computer-storage media of claim 10, the ad-selection procedures further comprising aggregating the location indicators of advertisements, the aggregated location indicators of advertisements are concurrently communicated to a web-browsing application that is executed on a computing device.

12. The one or more computer-storage media of claim 10, the system further comprising a call-parsing component for parsing the aggregated location indicators of advertisements such that each location indicator of an advertisement can be processed independently.

13. The one or more computer-storage media of claim 10, the system further comprising an image data gathering component for gathering image data incident to processing the location indicators of advertisements, the image data being gathered from one or more ad content servers, as directed by the location indicators of advertisements.

14. The one or more computer-storage media of claim 10, the ad-selection procedures further comprising:
parsing the ad-selection requests;
extracting parameters from the parsed ad-selection requests; and
distributing the parameters to back-end servers, the back-end servers configured to execute an algorithm for determining advertisements that correspond to the parameters.

15. One or more computer-storage media having computer-executable instructions embodied thereon that, when executed, perform a method for batching, in a response call, one or more location indicators of advertisements according to one or more ad-selection requests, the method comprising:
receiving a retrieval call from a web browser, the retrieval call comprising one or more ad-selection requests;
executing an ad-selection procedure, the ad-selection procedure comprising selecting the one or more location indicators of advertisements according to the one or more ad-selection requests;
packaging the one or more location indicators into a response call; and
communicating the response call to the web browser, the web browser configured to render a web page that is populated with ad content, the ad content associated with the one or more location indicators of advertisements.

16. The one or more computer-storage media of claim 15, wherein the one or more location indicators having a request link appended thereto, the request link targeting image data, wherein the image data being rendered as ad content on the user interface.

17. The one or more computer-storage media of claim 15, wherein the method further comprising storing information associated with the response call in association with at least one data store.

18. The one or more computer-storage media of claim 17, wherein the method further comprising parsing the retrieval call such that each of the one or more ad-selection requests can be processed independently.

19. The one or more computer-storage media of claim 15, wherein the ad-selection procedure further comprises:
extracting parameters from the one or more ad-selection requests; and
distributing the parameters to back-end servers that automatically select advertisements based on the parameters.

20. The one or more computer-storage media of claim 15, wherein communicating the response call to the web browser comprises:
loading a shared script library, wherein the shared script library comprises at least one function that is understood by the ad-delivering engine and the web browser; and
formatting underlying code of the response call by incorporating the at least one function of the shared script library.
